(19) United States
(12) Patent Application Publication
(10) Pub. No.: US 2026/0227911 A1
(43) Pub. Date: Aug. 6, 2026

(54) MULTI-STREAM READ CACHE MANAGEMENT FOR DATA STORAGE DEVICES

(71) Applicant: Western Digital Technologies, Inc., San Jose, CA (US)

(72) Inventors: Takahiro Oue, Kamakura (JP); Satoshi Kumagai, Machida (JP); Tomohisa Moko, Chigasaki (JP)

(21) Appl. No.: 19/044,448

(22) Filed: Feb. 3, 2025

(51) Int. Cl. G06F 3/06; G06F 12/0802

(52) U.S. Cl. CPC G06F 3/0613; G06F 3/0659; G06F 3/0676; G06F 12/0802

(57) ABSTRACT

A Data Storage Device (DSD) includes a disk to store data, a head configured to read data from the disk, and a memory to store cache segments for caching data read from the disk. Read commands are received from one or more hosts that each request data corresponding to different ranges of logical addresses. Internal prefetch commands are performed to cache prefetched data in cache segments with the prefetched data corresponding to subsequent ranges of logical addresses that sequentially follow the different ranges of logical addresses. The internal prefetch commands are performed in an order based on an overall time to move the head to perform the internal prefetch commands. In one aspect, a cache segment is designated as available for caching new data in response to completing a read command associated with a greatest logical address of data cached in the cache segment.

### BACKGROUND

Data Storage Devices (DSDs) are often used to record data onto or to reproduce data from storage media. One type of storage media includes a rotating disk, such as in a Hard Disk Drive (HDD). The read performance of a DSD is often measured in terms of how quickly data requested by a host can be returned from the DSD (i.e., latency performance) and how much data can be returned within a period of time (i.e., throughput performance).

One way to improve read performance for DSDs including disk media includes using “read-ahead” prefetching to continue reading data from a data track on the disk after performing a read command and caching the additional data in a read cache stored in a faster access memory, such as a Dynamic Random Access Memory (DRAM) of the DSD. Since data for a particular file or object is likely to be stored in the same track or in an adjacent track, a host requesting data related to previously requested data may send an additional read command for the related data, which may be cached or prefetched in the read cache from read-ahead prefetching. The prefetched data can then be provided to the host more quickly from the read cache to improve the read performance of the DSD.

The storage capacity of the read cache is limited and is typically managed by a Least Recently Used (LRU) cache management policy that discards or overwrites the data related to the oldest accessed data in the read cache. However, conventional read-ahead prefetching and the LRU policy can cause performance penalties for multi-stream read workloads that are becoming more common for disk-based DSDs. Multi-stream read workloads include receiving read commands for data or streams of data corresponding to different, non-sequential ranges of logical addresses (e.g., Logical Block Addresses (LBAs)) that are used by one or more hosts. With such multi-stream read workloads, DSDs often end up discarding older cached data for a first stream to make room in the read cache for data related to a second stream, even though the host may still send a new command for the discarded prefetched data for the first stream. In such cases, the DSD rereads the requested data from the disk that was discarded from the read cache, which causes a loss in read performance and an inefficient use of the read cache.

### BRIEF DESCRIPTION OF THE DRAWINGS

FIG. 1 is a plan view of an example Data Storage Device (DSD) according to one or more embodiments.

FIG. 2 illustrates an example of using internal prefetch commands according to one or more embodiments.

FIG. 3A illustrates a first part of an example of a multi-stream cache segment release policy according to one or more embodiments.

FIG. 3B illustrates a second part of the example of the multi-stream cache segment release policy of FIG. 3A according to one or more embodiments.

FIG. 3C illustrates a third part of the example of the multi-stream cache segment release policy of FIGS. 3A and 3B according to one or more embodiments.

FIG. 4 is a flowchart for an internal prefetch command process according to one or more embodiments.

FIG. 5 is a flowchart for an internal prefetch command ordering process according to one or more embodiments.

FIG. 6 is a flowchart for an internal prefetch command activation process according to one or more embodiments.

FIG. 7 is a flowchart for a multi-stream cache segment release process according to one or more embodiments.

FIG. 8 is a flowchart for a cache segment management process according to one or more embodiments.

FIG. 9 is a flowchart for a cache segment designation process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example Data Storage Device

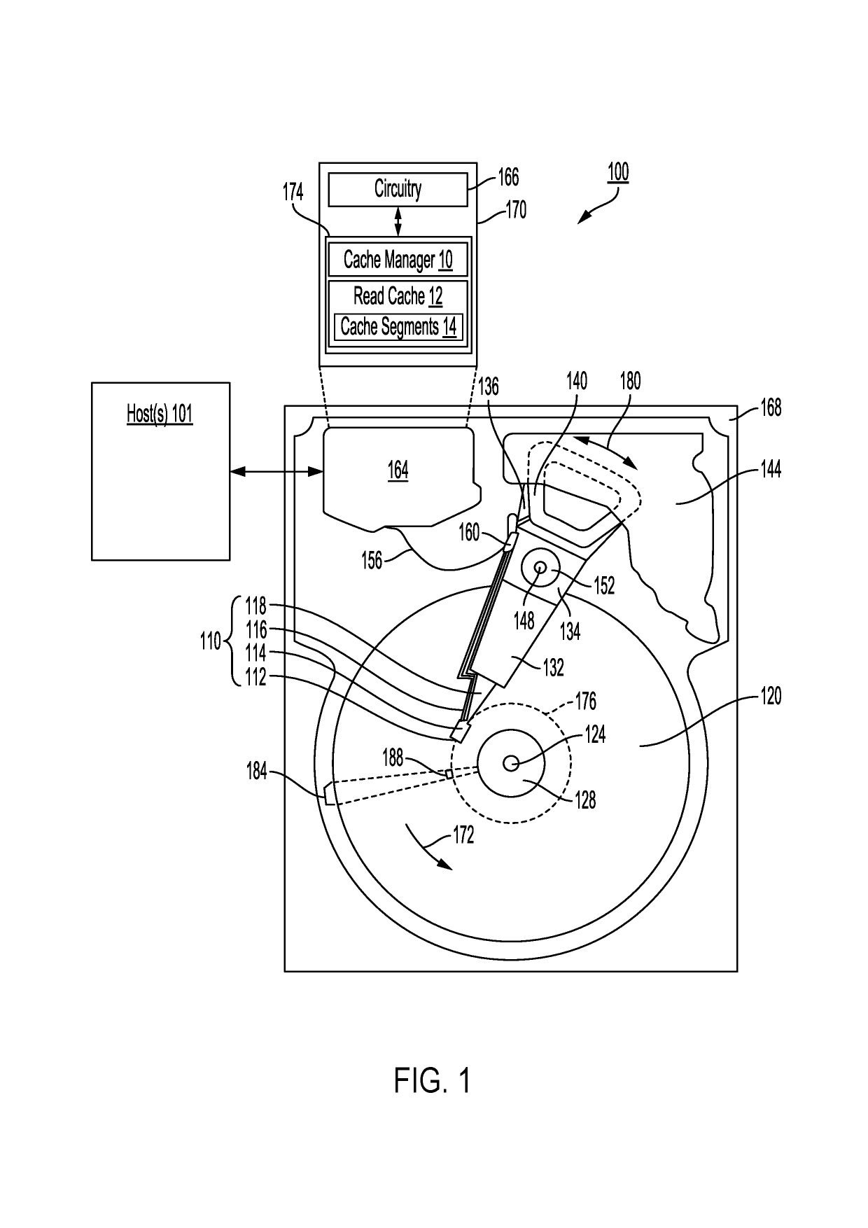

FIG. 1 is a plan view of example Data Storage Device (DSD) 100 according to one or more embodiments to illustrate an exemplary operating environment. In some implementations, DSD 100 can include a Hard Disk Drive (HDD) or other type of DSD including a rotating magnetic disk as a data recording medium, such as a Solid-State Hybrid Drive (SSHD) that can include solid-state non-volatile memory in addition to one or more disks.

In the example of FIG. 1, DSD 100 is in communication with one or more hosts 101 that send commands to DSD 100 to read and/or write data on disk 120. In some implementations, host(s) 101 and DSD 100 can form, for example, a computer system, such as a desktop, laptop, media player, or client and server. In this regard, host(s) 101 and DSD 100 may be housed separately, such as where host(s) 101 may be one or more clients accessing DSD 100 as a server. In other implementations, host(s) 101 and DSD 100 may be housed together as part of a single electronic device. In other implementations, host(s) 101 and DSD 100 may not be co-located and may be in different geographical locations.

As shown in the example of FIG. 1, DSD 100 includes slider 114 that comprises magnetic reading/recording head 112. Collectively, slider 114 and head 112 may be referred to as a head slider. DSD 100 further includes at least one Head Gimbal Assembly (HGA) 110 including the head slider, lead suspension 116 attached to the head slider typically via a flexure, and load beam 118 attached to lead suspension 116. Typically, the HGA includes multiple heads that are arranged to read and write data on multiple disk surfaces.

DSD 100 also includes at least one disk 120 rotatably mounted on spindle 124 and a drive motor (not visible) attached to spindle 124 for rotating disk 120. Head 112 includes a writer or write element and a reader or read element for respectively writing and reading data stored on disk 120 of DSD 100. Disk 120 or a plurality of disks stacked below disk 120 may be affixed to spindle 124 with disk clamp 128.

As shown in FIG. 1, DSD 100 further includes arm 132 attached to HGA 110, carriage 134, a Voice-Coil Motor (VCM) that includes armature 136 and voice coil 140 attached to carriage 134 and stator 144 including a voice-coil magnet (not visible). Armature 136 of the VCM is attached to carriage 134 and is configured to move arm 132 and HGA 110, to access portions of disk 120, being mounted on pivot shaft 148 with interposed pivot-bearing assembly 152. In the case of multiple disks, carriage 134 is called an "E-block," or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a Head Stack Assembly (HSA). An HSA may, however, include more or fewer components than those described. For example, an HSA may refer to an assembly that further includes electrical interconnection components. Generally, an HSA is the assembly configured to move the head slider to access portions of the disk 120 for read and write operations.

With further reference to FIG. 1, electrical signals (e.g., current to voice coil 140 of the VCM) comprising a write signal to and a read signal from head 112 are provided by flexible interconnect cable 156 ("flex cable"). Arm-Electronics (AE) module 160, which may have an on-board pre-amplifier for the read signal, as well as other read-channel and write-channel electronic components, provides connection between flex cable 156 and head 112. AE module 160 may be attached to carriage 134 as shown or may be included as part of circuitry 166 of controller 170. Flex cable 156 is coupled to electrical connector block 164, which provides electrical communication to controller 170 located beneath electrical connector block 164 through electrical feedthroughs provided by base or housing 168. In conjunction with a cover, housing 168 provides a sealed, protective enclosure for the data storage components of DSD 100.

Other electronic components, including a disk controller and servo electronics that can further include a Digital Signal Processor (DSP), provide electrical signals to the drive motor, voice coil 140 of the VCM and head 112 of the HGA 110. The electrical signal provided to the drive motor enables the drive motor to spin providing a torque to spindle 124, which is in turn transmitted to disk 120 that is affixed to spindle 124. As a result, disk 120 spins in direction 172. The disk 120 creates a cushion of gas that acts as a gas-bearing on which the Gas-Bearing Surface (GBS) of slider 114 rides so that slider 114 flies above the surface of disk 120 without contacting a thin magnetic-recording layer of disk 120 in which data is recorded.

The electrical signal provided to voice coil 140 of the VCM enables head 112 of HGA 110 to access tracks, such as track 176, in which data is recorded. Thus, armature 136 of the VCM swings through an arc 180, which enables head 112 of HGA 110 to access various tracks on disk 120. Data is stored on disk 120 in a plurality of radially nested tracks arranged in sectors on disk 120, such as sector 188 of track 176 within wedge 184. Each track on the disk surface is composed of a plurality of sectors, such as sector 188, that may store recorded data and a header containing a servo-burst-signal pattern. The servo-burst signal pattern may include, for example, an ABCD-servo-burst-signal pattern, which is information that identifies track 176, and error correction code information. In accessing track 176, the read element of head 112 of HGA 110 reads the servo-burst-signal pattern, which provides a Position-Error-Signal (PES) to the servo electronics, which controls the electrical signal provided to voice coil 140 of the VCM, enabling head 112 to follow track 176. Upon finding track 176 and identifying sector 188, head 112 either reads data from track 176 or writes data to track 176 depending on instructions, such as instructions received by controller 170 from an external host 101, such as a microprocessor of a computer system.

In the example of FIG. 1, controller 170 is shown with dashed lines connected to electrical connector block 164 to indicate that controller 170 is in electrical communication with electrical connector block 164. As will be appreciated by those of ordinary skill in the art, controller 170 in some implementations can include a Printed Circuit Board (PCB) coupled to the bottom side of DSD 100, such as to housing 168. As shown in the example of FIG. 1, controller 170 includes circuitry 166 and at least one memory 174, which can include a Dynamic Random Access Memory (DRAM) or other solid-state memory, such as a Storage Class Memory (SCM) used to access data quickly.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, Electrically Erasable Programmable Read-Only Memory (EEPROM), Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), Magnetoresistive RAM (MRAM), and/or other discrete Non-Volatile Memory (NVM) chips, or any combination thereof.

Circuitry 166 can comprise electronic components for performing different functions for operation of the DSD, such as an interface controller, a Read/Write Integrated Circuit (R/W IC), an AE module, a motor drive, a servo processor, and other digital processors and associated memory. In this regard, circuitry 166 can include one or more processors for executing instruction, such as a microcontroller, a DSP, an Application-Specific Integrated Circuit (ASIC), a Field Programmable Gate Array (FPGA), a Graphics Processing Unit (GPU), hard-wired logic, analog circuitry, and/or a combination thereof. In some implementations, circuitry 166 can include a System on a Chip (SoC), which may also include one or more memories of a least one memory 174.

As shown in FIG. 1, at least one memory 174 stores cache manager 10 and read cache 12, which includes cache segments 14. As discussed in more detail below, cache segments 14 (i.e., read buffers) can be used to cache data read from disk 120 for performing read commands received from one or more hosts, such as host(s) 101. In some implementations, each cache segment 14 may have a predetermined data storage capacity, such as corresponding to a certain number of sectors on disk 120.

In addition, cache segments 14 can cache additional data (i.e., additional prefetched data) that corresponds to a range of logical addresses that sequentially follow an initial range of logical addresses that includes the data requested by the read command. This prefetching of data can improve the read performance of DSD 100 so that future read commands from host(s) 101 for data that may be part of a read stream or associated with a larger range of logical addresses can be performed by returning the prefetched data from the cache segment to the requesting host. This typically improves the read performance of the DSD, since data can be prefetched relatively quickly by continuing to read data in the same track or in an adjacent track, and the prefetched data can be returned for a new read command from the faster access solid-state memory 174, as compared to waiting for the disk to rotate to a particular starting location for the new read command and/or moving head 112 to a particular track for the new read command.

As discussed in more detail below, cache manager 10 can use internal prefetch commands to read additional data that follows data read for a host read command to prefetch data in a cache segment 14 of read cache 12. The performance of the internal prefetch commands can be ordered based at least in part on an overall time to move one or more heads of the HGA to respective disk locations to perform the internal prefetch commands. This ordinarily improves read performance of multi-stream read workloads over conventional read-ahead prefetching, since the order of prefetching is not primarily determined by the order in which read commands are received from a host, which may cause read-ahead prefetching in scattered locations across one or more disk surfaces. Instead, the internal prefetch commands of the present disclosure take greater advantage of the sequential or contiguous nature of each stream to prefetch data corresponding to subsequent ranges of logical addresses (e.g., Logical Block Addresses) in an order that reduces an overall time to move at least one head to the different locations on the at least one disk. The reduction in time can be accomplished by reducing idle time when the head may need to wait for a disk to rotate to reach a starting location to begin reading data and/or by reducing a seek time in moving a head or HGA from one radial disk location to another.

In addition, cache manager 10 can use a multi-stream cache segment release policy that is better suited to multi-stream read workloads by designating cache segments as available for caching newly read data in response to completing a read command that is associated with a greatest logical address of the data stored in the cache segment. This ordinarily improves the read performance of multi-stream workloads over a conventional Least Recently Used (LRU) cache policy, since it is unlikely for a read stream that data in the cache segment corresponding to lower logical addresses will be requested by the host after the data corresponding to the greatest logical address has been requested. The released cache segment then becomes available to cache data for another stream or for the same stream, instead of releasing the LRU cache segment that caches prefetched data for another stream that may still have a new read command.

With reference to FIG. 1, cache manager 10 can include computer-executable instructions executed by circuitry 166, such as part of a firmware of the DSD, for managing the caching of data in cache segments 14. In some implementations, cache manager 10 may also manage a write cache used to cache received data for write commands to store data on disk 120 or another disk that is circumferentially aligned with disk 120.

As will be appreciated by those of ordinary skill in the art with reference to the present disclosure, other implementations of DSD 100 may differ from the example shown in FIG. 1. For example, circuitry 166, or portions thereof, may be located outside of controller 170 in other implementations, such as by forming part of AE module 160. As another example, the one or more memories 174 in FIG. 1 may also include a write cache for caching data to be written on disk 120.

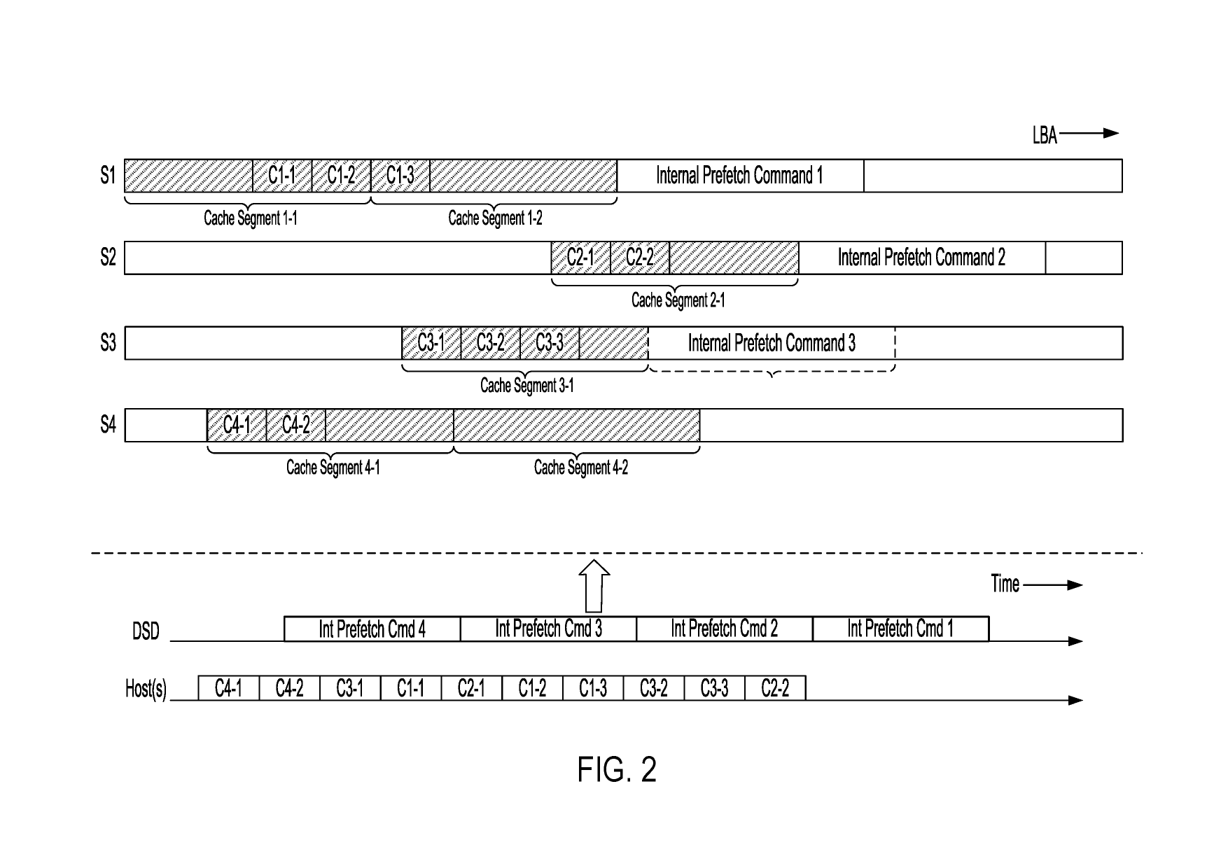

FIG. 2 illustrates an example of using internal prefetch commands according to one or more embodiments. As shown in FIG. 2, there are four read streams— S1, S2, S3, and S4, that are associated with different non-sequential or non-contiguous ranges of logical addresses (i.e., LBAs in FIG. 2). Each read stream includes read commands received by a DSD (e.g., DSD 100 in FIG. 1) from one or more hosts (e.g., host(s) 101 in FIG. 1) for the respective ranges of logical addresses. The logical addresses in the different ranges increase from left to right. Although read streams S1 to S4 are shown in FIG. 2 as overlapping, this is for the purposes of illustration, and the non-sequential ranges of logical addresses for the different read streams do not overlap.

In the bottom portion of FIG. 2 below the dashed line, the temporal order of read commands received from the host and the performance of commands by the DSD are shown with time increasing from left to right. The host commands are performed by a host task or host process executed by circuitry of the DSD to identify the requested data and obtain it from the cache segments and send the requested data back to the requesting host. The internal prefetch commands are performed by a DSD task or DSD process executed by circuitry of the DSD to read data from one or more disks of the DSD and cache the read data in the cache segments.

The upward arrow above “Int Prefetch Cmd 3” indicates the point in time for the cache segments shown above the dashed line for the read streams. At the point in time indicated by the upward arrow, the DSD has received read commands C4-1, C4-2, C3-1, C1-1, C2-1, and C1-2 from the host(s), and is in the process of receiving read command C1-3 from the host(s). In addition, at the time indicated by the upward arrow, the DSD has performed internal prefetch command 4 (i.e., Int Prefetch Cmd 4), and is in the process of performing internal prefetch command 3 (i.e., Int Prefetch Cmd 3).

As shown above the dashed line in FIG. 2, the cross-hatched portions of the read streams indicate the data that is cached in cache segments of the read cache (e.g., cache segments 14 of read cache 12 in FIG. 1) at the time indicated by the upward arrow. The data for the first two read commands received from the host(s) in the example of FIG. 2, C4-1 and C4-2, are already cached in cache segment 4-1 with other prefetched data corresponding to logical addresses that sequentially follow the requested data. The requested data for the first two read commands can be quickly provided to the requesting host using the prefetched data for these commands.

A DSD task or DSD process of a cache manager (e.g., cache manager 10 in FIG. 1) dispatches the first internal prefetch command, “Int Prefetch Cmd 4”, in response to nearly filling (e.g., 75% to 95%) cache segment 4-1 with data. In the example of FIG. 2, internal prefetch command 4 is dispatched before receiving any commands from a host for data that will be cached in cache segment 4-2. Internal prefetch command 4 caches additional prefetched data corresponding to a subsequent range of logical addresses that sequentially follows an initial range of logical addresses corresponding to the prefetched data cached in cache segment 4-1. Notably, internal prefetch command 4 is performed even though another read command has been received by the DSD for a different read stream with the receipt of read command C3-1. Cache segment 4-2 is filled with prefetched data for read stream S4 in anticipation of receiving additional read commands for read stream S4.

A conventional system would not continue to fill another cache segment for read stream S4 without receiving additional read commands for the read stream and would instead focus on performing read commands C3-1 and C1-1. However, performing read commands for multi-stream workloads in this way can reduce the read performance of the DSD as compared to the present disclosure’s use of internal prefetch commands by not being able to take greater advantage of prefetching sequentially addressed data despite the interspersing of read commands for different read streams.

After filling cache segment 4-2 with prefetched data for internal prefetch command 4, the DSD performs internal prefetch command 3, which caches additional prefetched data corresponding to a subsequent logical address range that follows an initial logical address range corresponding to the data cached in cache segment 3-1. The data for read command C3-1 can be provided to the requesting host using the prefetched data in cache segment 3-1.

Internal prefetch command 3 is shown in dashed lines for read stream S3 with a dashed bracket for a cache segment, because the DSD is in the process of performing internal prefetch command 3 for the subsequent logical address range. According to one aspect of the present disclosure, a multi-stream cache segment release policy is used when multiple read steams are detected to replace or reduce the use of a conventional LRU cache management policy. In some implementations, the DSD may monitor the logical addresses for received read commands and determine that there are at least two active read streams when there are different groups of read commands whose logical addresses differ by a threshold number of logical addresses. In some implementations, this determination or detection of multiple read streams may not be made until after a threshold number of read commands for each read stream has been received or after a predetermined period of time from receiving the first read command for the first detected read stream has elapsed.

For the multi-stream cache release policy, cache segments are designated as being available for caching newly read data in response to completing a read command that is associated with a greatest logical address of the data stored in the cache segment. The read command may be associated with the greatest logical address for the cache segment in that the greatest logical address corresponds to at least a portion of the data requested by the read command. The completion of a read command can, for example, refer to the sending of requested data for the command to a requesting host, the queuing of the requested data in a data transmission queue of the DSD, the packaging of the requested data in a packet, or other type of preparation or stage in responding to the read command.

In the example of FIG. 2, the multi-stream cache segment release policy can result in cache segment 1-1 being reused for internal prefetch command 3 for S3 without having to overwrite or erase a least recently used or accessed cache segment (i.e., the least recently used cache segment for completing a read command), which may still cache prefetched data for another stream that may soon be requested by a host. Such cache management is better suited to the multi-stream workloads that may be associated with scattered ranges of logical addresses for the different streams, as compared to using a LRU cache management policy.

After filling a cache segment for internal prefetch command 3, the DSD performs internal prefetch command 2 to read prefetched data for read stream S2. The requested data for read command C2-1 can be provided to the requesting host using the prefetched data in cache segment 2-1. Notably, internal prefetch command 2 is performed before internal prefetch command 1, even though read command C1-1 is received before read command C2-1.

As discussed above, the ordering of the performance of the internal prefetch commands reduces an overall time to move one or more heads of the DSD (e.g., head 112 in FIG. 1) to the different positions for performing the internal prefetch commands, rather than following an order determined primarily by the order in which the read commands are received from the one or more hosts. This ordinarily improves the read performance in terms of both throughput performance (i.e., the amount of requested data that can be returned in a given timeframe) and latency performance (i.e., the time it takes to return requested data), because more data can be prefetched for each stream in a shorter period of time by taking advantage of the sequential or contiguous nature of the read streams. In some implementations, the ordering of the internal prefetch commands to reduce the overall time to move the one or heads may be accomplished at least in part with a Rotational Position Optimization (RPO) algorithm.

The last internal prefetch command in the example of FIG. 2, internal prefetch command 1, is performed after internal prefetch command 2 to cache additional prefetched data corresponding to a subsequent logical address range that follows an initial logical address range corresponding to the prefetched data in cache segment 1-2, which includes requested data for read command C1-3. The order of performing internal prefetch command 1 after performing internal prefetch command 2 is based on reducing the amount of seeking or movement of one or more heads with respect to the disk or disks. This can improve the read performance of the DSD by ordering the performance of the internal prefetch commands to spend more time reading data from the disk(s) and less time moving from one track location to another track location across the disk(s).

Those of ordinary skill in the art will appreciate with reference to the present disclosure that other examples of using internal prefetch commands are possible and that the example of FIG. 2 is for the purposes of illustration. For example, other examples of using internal prefetch commands can include a different number of read commands and read streams.

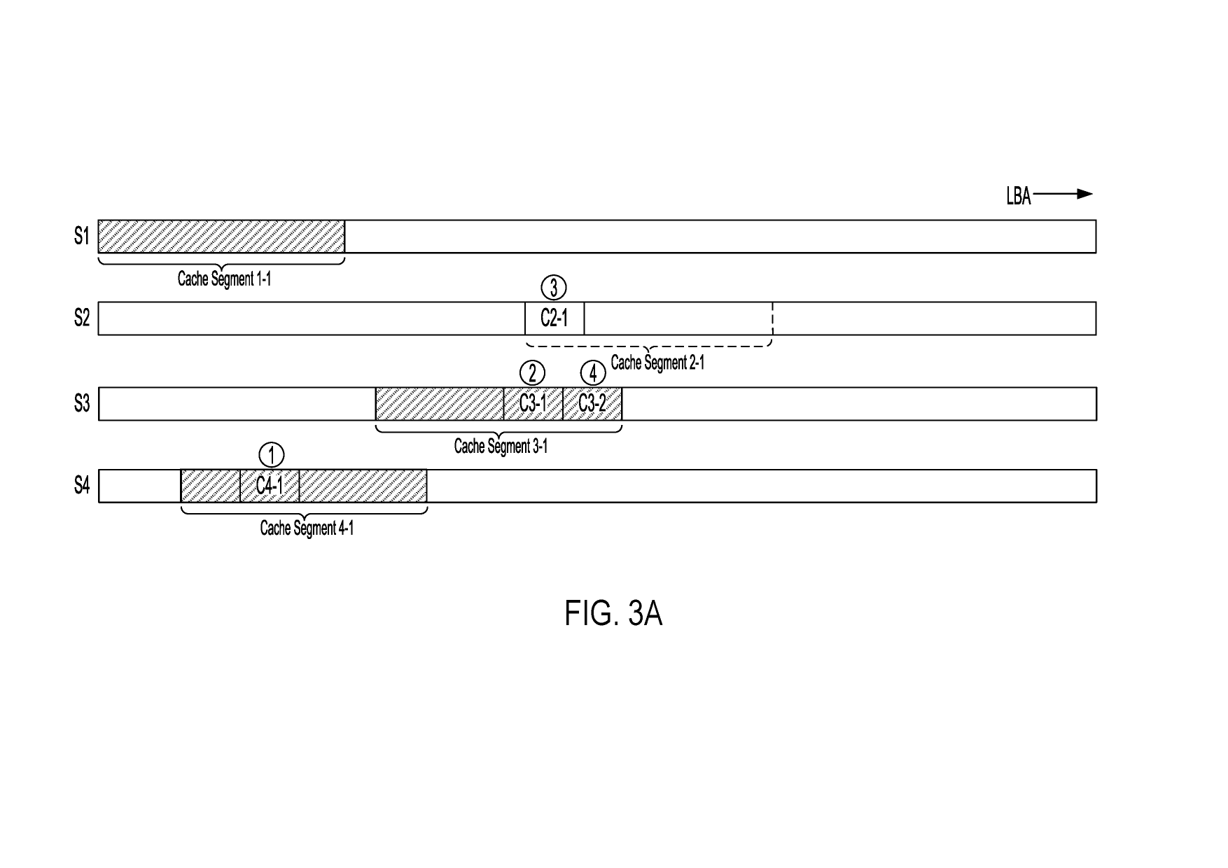

FIG. 3A illustrates a first part of an example of a multi-stream cache segment release policy according to one or more embodiments. As shown in the example of FIG. 3A, there are four read streams— S1, S2, S3, and S4, and the cross-hatched sections of the read streams indicate data cached in respective cache segments. Specifically, S1 has data cached in cache segment 1-1, S3 has data cached in cache segment 3-1, and S4 has data cached in cache segment 4-1. A DSD task is in the process of caching data in cache segment 2-1 for S2, as indicated by the dashed lines in S2.

The circled numbers in FIG. 3A indicate an order of execution of the commands, with read command C4-1 being the first command performed, such as by a host task of the DSD identifying and obtaining the requested data for command C4-1 before sending it to a requesting host. Read command C3-1 is then performed for S3, and then read command C2-1 is performed for S2. Read command C3-2 is performed last in FIG. 3A.

Cache segment 1-1 for S1 is the LRU cache segment in the example of FIG. 3A and would conventionally be released or designated as being available for caching newly read data if there were a need for more cache segments or read buffers. In contrast, the multi-stream cache segment release policy of the present disclosure retains the cached data in cache segment 1-1, and instead releases cache segment 3-1 in response to the completion of read command C3-2 at the end of cache segment 3-1 in terms of logical addressing or LBAs. The DSD in the present disclosure (e.g., via a cache manager) can monitor the progress of each read stream and when the commands completed for a stream reach the end of a cache segment, the cache segment is designated as available for caching newly read data.

As shown in FIG. 3B, commands C1-1 and C1-2 are received for S1 and can be performed by a host task of the DSD identifying and obtaining the prefetched data for the commands from cache segment 1-1. Cache segment 1-1 is no longer the LRU cache segment, since data has been used from this cache segment for commands C1-1 and C1-2. Cache segment 4-1 now becomes the new LRU cache segment, since it has least recently been used to complete a read command. As noted above, the multi-stream cache segment release policy of the present disclosure improves the read performance of the DSD for multi-stream read workloads by replacing or reducing the use of a LRU cache management policy, such as by only using a LRU cache policy for multi-stream read workloads when there are no cache segments available for caching data while the multi-stream cache segment release policy is active.

As shown in FIG. 3B, cache segment 3-1 is released with the completion of read command C3-2 in FIG. 3A and can be reused for cache segment 3-2 in caching data, including the requested data for read command C3-3 in FIG. 3B. This is in contrast to a conventional LRU cache management policy where the LRU cache segment 4-1 would be released to be reused as cache segment 3-2. The prefetched data cached in cache segment 1-1 can be used to complete commands C1-1 and C1-2 for S1, and the prefetched data cached in cache segment 2-1 can be used to complete command C2-2 for S2.

In FIG. 3C, cache segment 1-1 is released in response to the completion of read command C1-2 associated with a greatest LBA of data cached in the cache segment, in accordance with the multi-stream cache segment release policy. In this regard, cache segment 1-1 is released instead of the LRU cache segment 4-1 for S4. As shown in FIG. 3C, read command C4-2 is received and performed last using data prefetched in LRU cache segment 4-1. The requested data for read command C4-2 is available for completing the read command by the host task much faster than if cache segment 4-1 had been released using a LRU cache management policy. In this scenario, the DSD would have had to reread the requested data for read command C4-2 from the disk, which would have taken longer than providing the prefetched data for this command from cache segment 4-1 as in FIG. 3C.

Those of ordinary skill in the art will appreciate with reference to the present disclosure that other examples of the multi-stream cache segment release policy may differ from the example of FIGS. 3A to 3C. For example, the multi-stream cache segment release policy may be used in some implementations without using the internal prefetch commands discussed above as in the example of FIG. 2. In such implementations, the management of the read cache may be improved as compared to using a conventional LRU cache management policy, but the use of internal prefetch commands ordinarily provides further read performance improvement for multi-stream read workloads.

### Example Processes

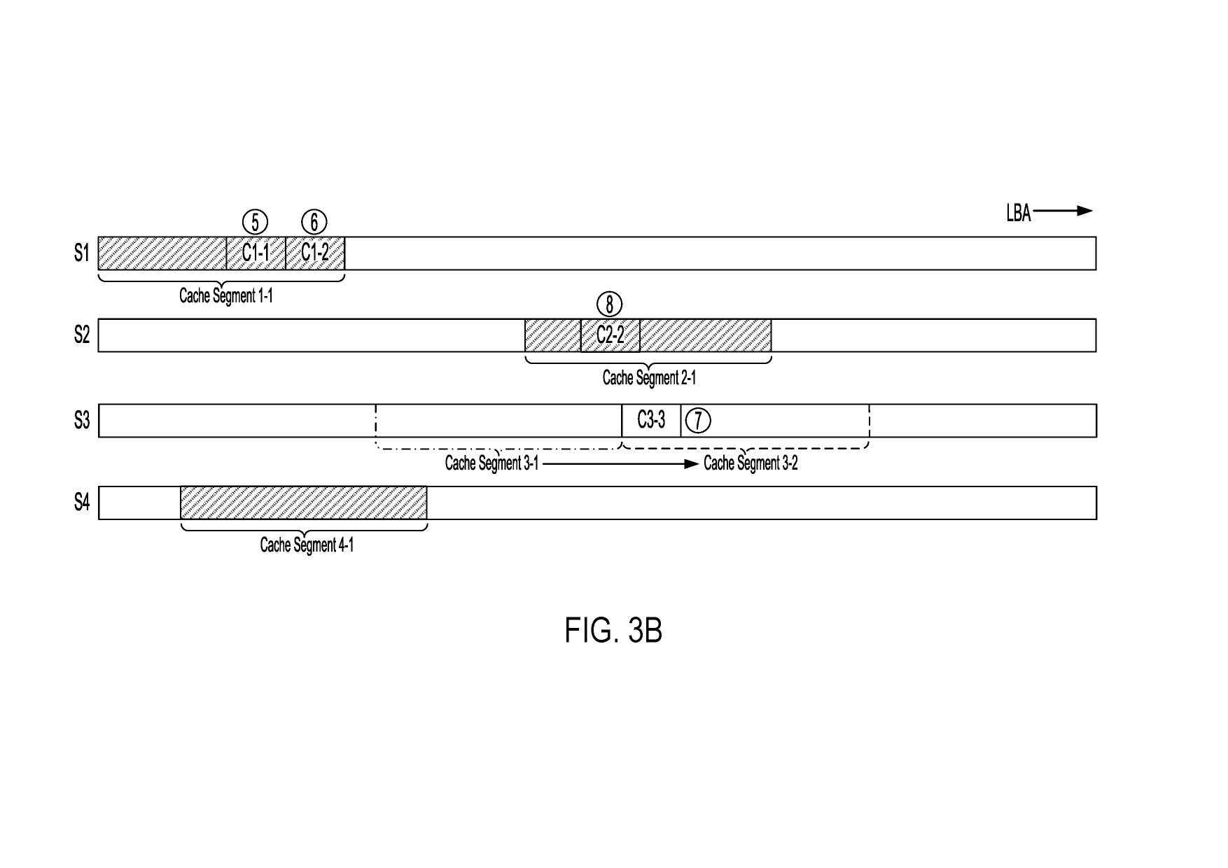

FIG. 4 is a flowchart for an internal prefetch command process according to one or more embodiments. The process of FIG. 4 can be performed by, for example, circuitry 166 of DSD 100 executing cache manager 10 in FIG. 1. In this regard, circuitry 166 can, in some implementations, comprise a means for performing the functions of the internal prefetch command process of FIG. 4.

In block 402, the DSD receives read commands from one or more hosts. Each read command requests data stored on one or more disks of the DSD that corresponds to different ranges of logical addresses. The different ranges of logical addresses can be for different read streams that request data within the different ranges of logical addresses or within subsequent ranges of logical addresses that sequentially follow or are contiguous with the different ranges. With reference to the example discussed above for FIG. 2, the different ranges can include the LBAs for the data requested for read streams S1 to S4.

In block 404, the DSD performs internal prefetch commands to cache prefetched data in respective cache segments of a read cache (e.g., cache segments 14 of read cache 12 in FIG. 1). The cached prefetched data corresponds to subsequent ranges of logical addresses that sequentially follow the different ranges of logical addresses.

Notably, the internal prefetch commands are performed in an order based at least in part on an overall time to move one or more heads of the DSD (e.g., head 112 in FIG. 1) to respective locations of the one or more disks for reading the data for the internal prefetch commands. The overall time to move the one or more heads can attempt to reduce an idle time when a head may need to wait for a disk to rotate to reach a starting location to begin reading data and/or to reduce a seek time in moving the head from one radial location to another radial location to begin reading data. In some implementations, the DSD may use an RPO algorithm for ordering the internal prefetch commands.

As noted above, ordering internal prefetch commands to reduce the latency in reading the data from the disk(s) can improve the read performance of the DSD for multi-stream read workloads. In this regard, the DSD can order the internal prefetch commands with greater independence from the order in which read commands are received from one or more hosts, which can allow the DSD to take better advantage of the sequential nature of read streams despite the individual read commands for the different streams being interspersed for scattered locations across the one or more disks.

Those of ordinary skill in the art will appreciate with reference to the present disclosure that other ways of performing an internal prefetch command process are possible. For example, in some implementations, the DSD may wait for a period of time before enabling the internal prefetch commands in block 404 to ensure that the read commands are actually associated with ongoing read streams.

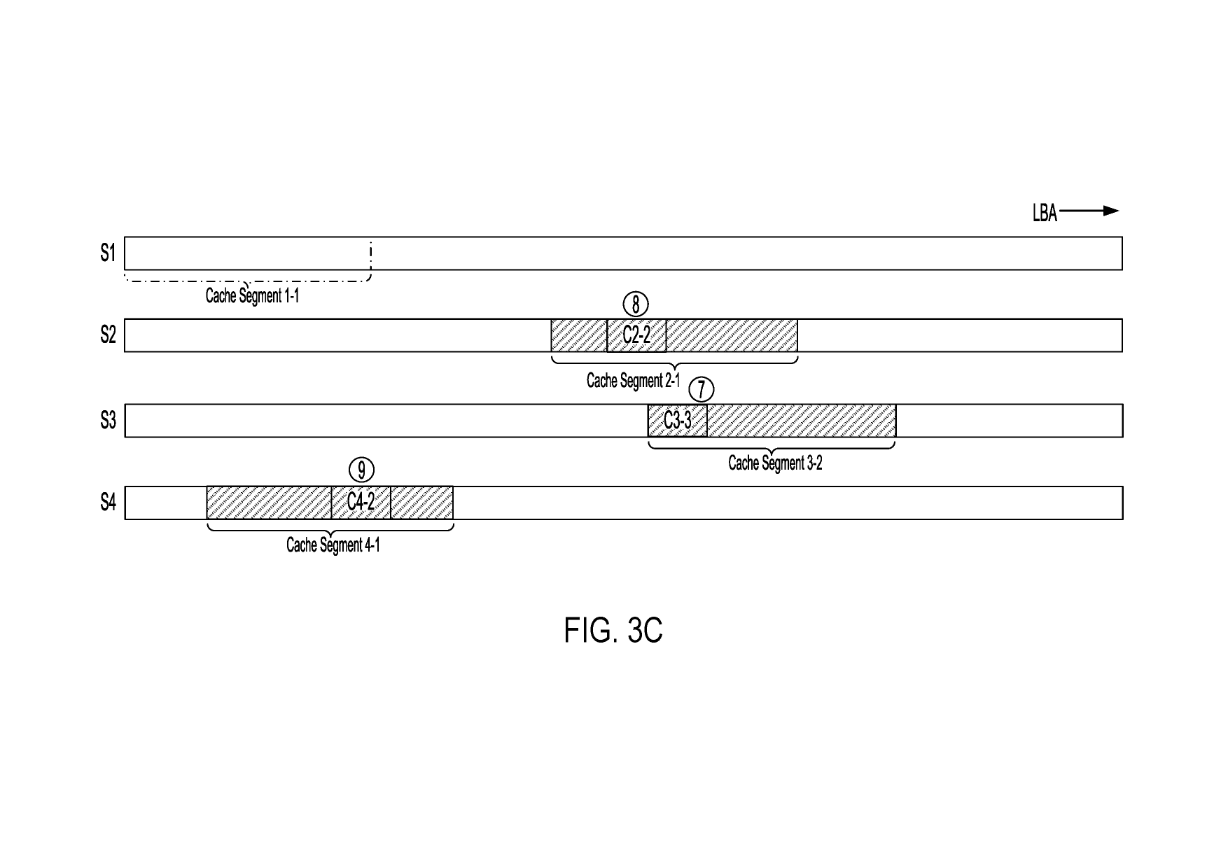

FIG. 5 is a flowchart for an internal prefetch command ordering process according to one or more embodiments. The process of FIG. 5 can be performed by, for example, circuitry 166 of DSD 100 executing cache manager 10 in FIG. 1. In this regard, circuitry 166 can, in some implementations, comprise a means for performing the functions of the internal prefetch command ordering process of FIG. 5. In some implementations, the process of FIG. 5 may form part of the internal prefetch command process of FIG. 4 discussed above.

In block 502, a first read command is received from a host requesting first data stored on at least one disk of the DSD. The first data corresponds to a first logical address within an initial range of logical addresses.

In block 504, a first read command is performed by at least in part caching first prefetched data in a first cache segment. The first prefetched data corresponds to an initial range of logical addresses and includes the first data requested by the first read command. In this regard, an initial caching of data for a read stream can be based on the location of an initial read command for the read stream, and additional data can be prefetched that logically follows the requested data in terms of logical addressing in anticipation of further read commands for the read stream.

In block 506, a second read command is received from the host or from another host after receiving the first read command but before performing an internal prefetch command to cache additional prefetched data corresponding to a first range of logical addresses that sequentially follows the initial range of logical addresses. The second read command requests second data stored on the at least one disk of the DSD that is not included in either the first prefetched data or in the additional prefetched data. The second read command can be for a different read stream than the read stream that includes the first read command. In other words, the data requested for the second read command corresponds to a logical address or logical addresses not included in the initial range of logical addresses or in the subsequent range of logical addresses, and may therefore be located in a relatively distant (e.g., radially distant) location on the one or more disks from the location of the data requested for the first read command and the data prefetched for the internal prefetch command.

In block 508, an internal prefetch command is performed to cache the additional prefetched data in a second cache segment. The additional prefetched data corresponds to a first range of logical addresses that sequentially follows the initial range of logical addresses used for the first cache segment.

In block 510, the additional prefetched data from the internal prefetch command is cached in the second cache segment before caching the requested second data for the second read command in a cache segment. Despite receiving the second read command from a host before performing the internal prefetch command, the DSD continues prefetching data after the first prefetched data, since the additional prefetched data is likely to be requested later on for the first read stream, and it is more efficient to continue sequentially reading data from the disk than to return to this location after performing the second read command.

Those of ordinary skill in the art will appreciate with reference to the present disclosure that other implementations of the internal prefetch command reordering process of FIG. 5 may differ. For example, the process of FIG. 5 may comprise just a portion of a multi-stream read workload as in the examples of FIG. 2 or FIGS. 3A to 3C discussed above. As discussed above for FIG. 2, the internal prefetch commands can be performed with greater independence from the order in which the read commands are received by the DSD for the different read streams.

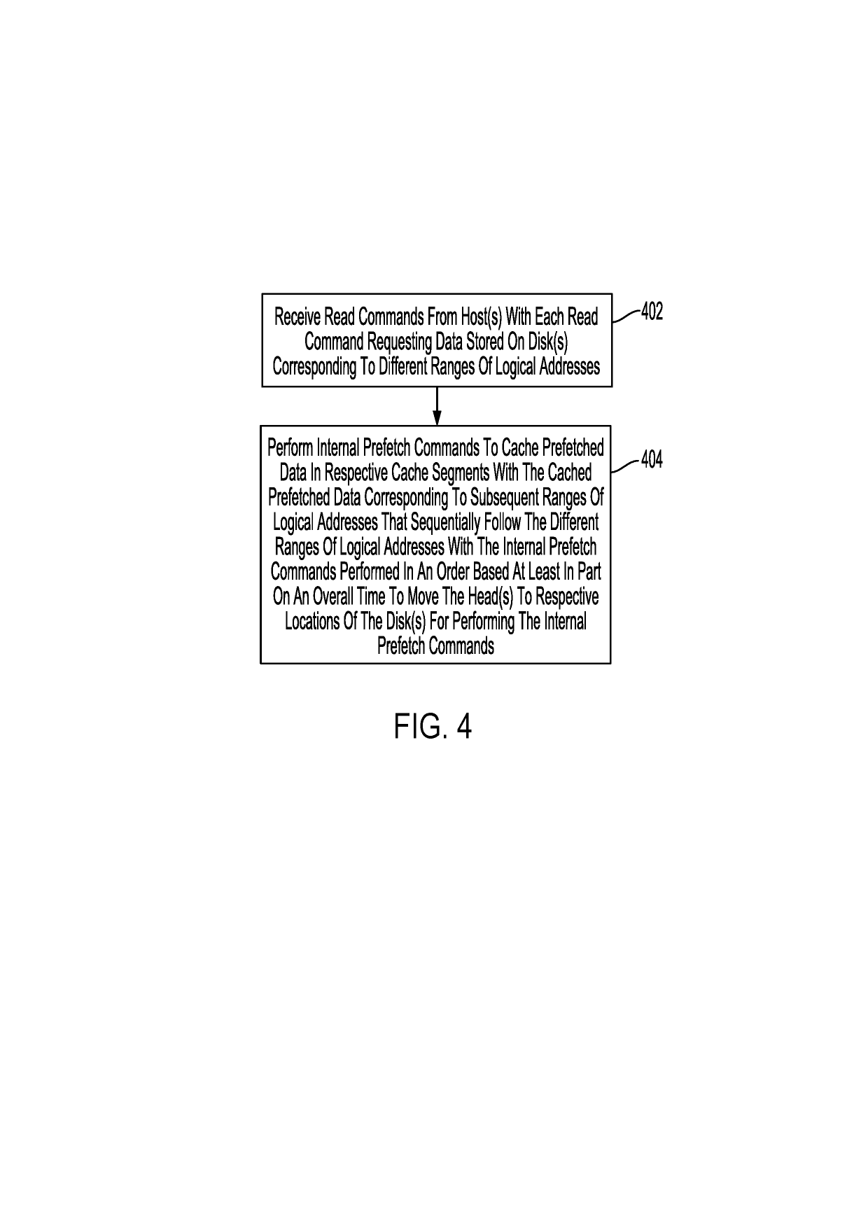

FIG. 6 is a flowchart for an internal prefetch command activation process according to one or more embodiments. The process of FIG. 6 can be performed by, for example, circuitry 166 of DSD 100 executing cache manager 10 in FIG. 1. In this regard, circuitry 166 can, in some implementations, comprise a means for performing the functions of the internal prefetch command activation process of FIG. 6.

In block 602, read commands are received from one or more hosts requesting respective data corresponding to logical addresses within respective ranges of logical addresses. In this regard, the read commands may indicate a single logical address or a range of logical addresses, such as by providing a starting logical address and a length for the data to be read.

In block 604, the DSD determines that the read commands are associated with at least two different read streams that correspond to different non-sequential ranges of logical addresses. The determination may include, for example, monitoring the logical addresses of data requested by the host or hosts to determine whether the logical addresses are grouped into different ranges of logical addresses corresponding to different read streams. In some implementations, requests for data associated with logical addresses that differ by more than a predetermined number of addresses can be identified as separate read streams.

In block 606, the DSD performs internal prefetch commands in response to determining that the read commands are associated with at least two different read streams. As discussed above, the internal prefetch commands can be performed by a DSD task or DSD process that can continue to cache or prefetch data into a cache segment before receiving any commands from a host to read data of the additional prefetched data.

Those of ordinary skill in the art will appreciate with reference to the present disclosure that other implementations of the internal prefetch command activation process of FIG. 6 may differ. For example, the activation of internal prefetch commands may require a different number of read streams than two, as in the example process discussed above. In other implementations, the circuitry may not activate the use of internal prefetch commands until determining that there are at least three read streams, for example. As another example variation, other implementations may require a threshold number of read commands for the different read streams and/or a threshold period of time for the different read streams to be active before switching to using internal prefetch commands.

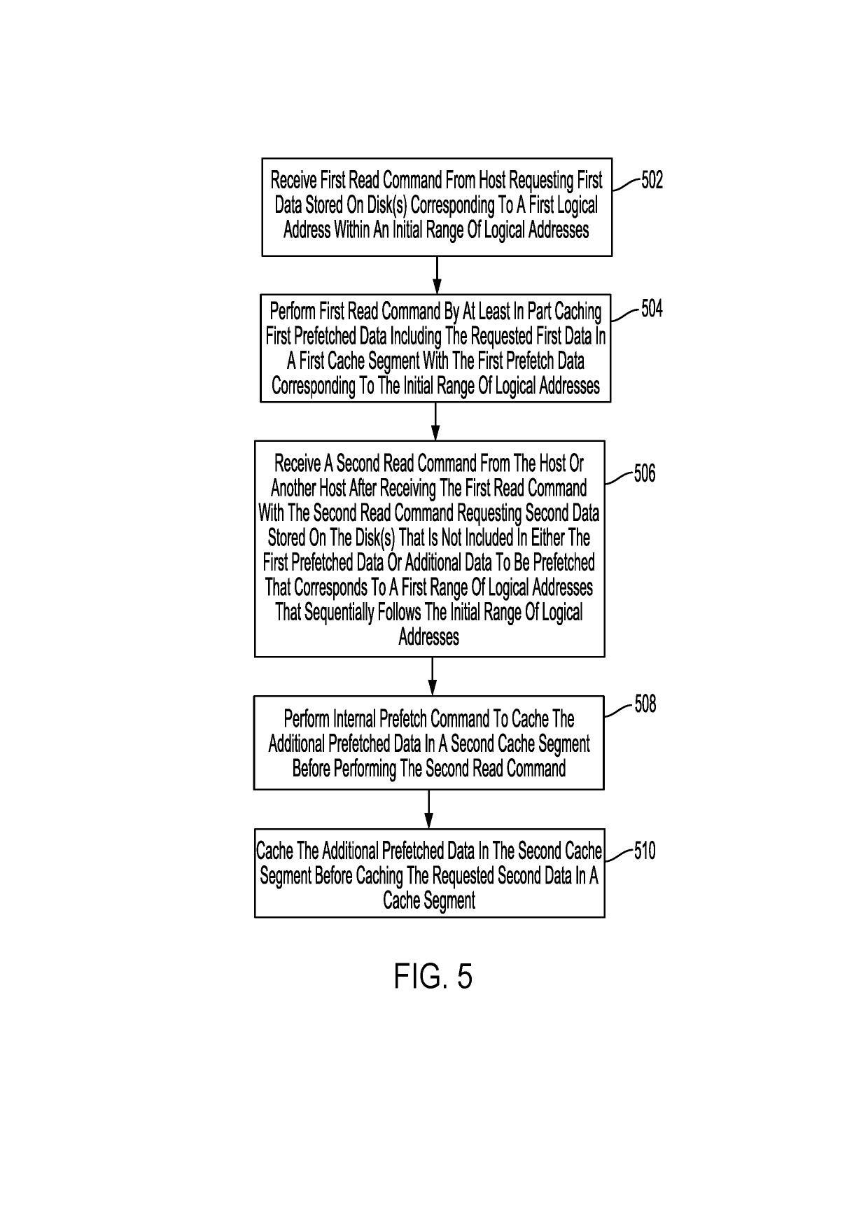

FIG. 7 is a flowchart for a multi-stream cache segment release process according to one or more embodiments. The process of FIG. 7 can be performed by, for example, circuitry 166 of DSD 100 executing cache manager 10 in FIG. 1. In this regard, circuitry 166 can, in some implementations, comprise a means for performing the functions of the multi-stream cache segment release process of FIG. 7.

In block 702, the DSD receives read commands from one or more hosts to read data from at least one disk of the DSD. In some implementations, the read commands may be associated with different read streams requesting data in different logical address ranges. In other implementations, the read commands may be associated with only a single read stream or may represent discrete read commands that are not related to one another.

In block 704, the DSD caches data read from the at least one disk in cache segments of a read cache (e.g., cache segments 14 of read cache 12 in FIG. 1). The data cached in the cache segments can include data requested by the read commands and may also include additional data that is physically located on a disk surface in a sequential or contiguous location to the data requested by the read commands, such as data located in the same track or in an adjacent track. In this regard, the cache segments may have a predetermined storage capacity for caching the requested data and the additional data, such as the amount of data stored in a particular number of sectors on the disk surface.

In block 706, a cache segment is designated as being available for caching other data in response to completing a read command associated with a greatest logical address of the data cached in the cache segment. As discussed above for the example of FIG. 3, such a read cache management policy is ordinarily better suited to multi-stream read workloads as compared to a LRU cache management policy that would otherwise designate the cache segment that least recently provided data for a read command. The completion of a read command in block 706 can refer to, for example, the sending of requested data for the command to a requesting host, the queuing of the requested data in a data transmission queue of the DSD, the packaging of the requested data in a packet, or another type of preparation or stage in responding to the read command.

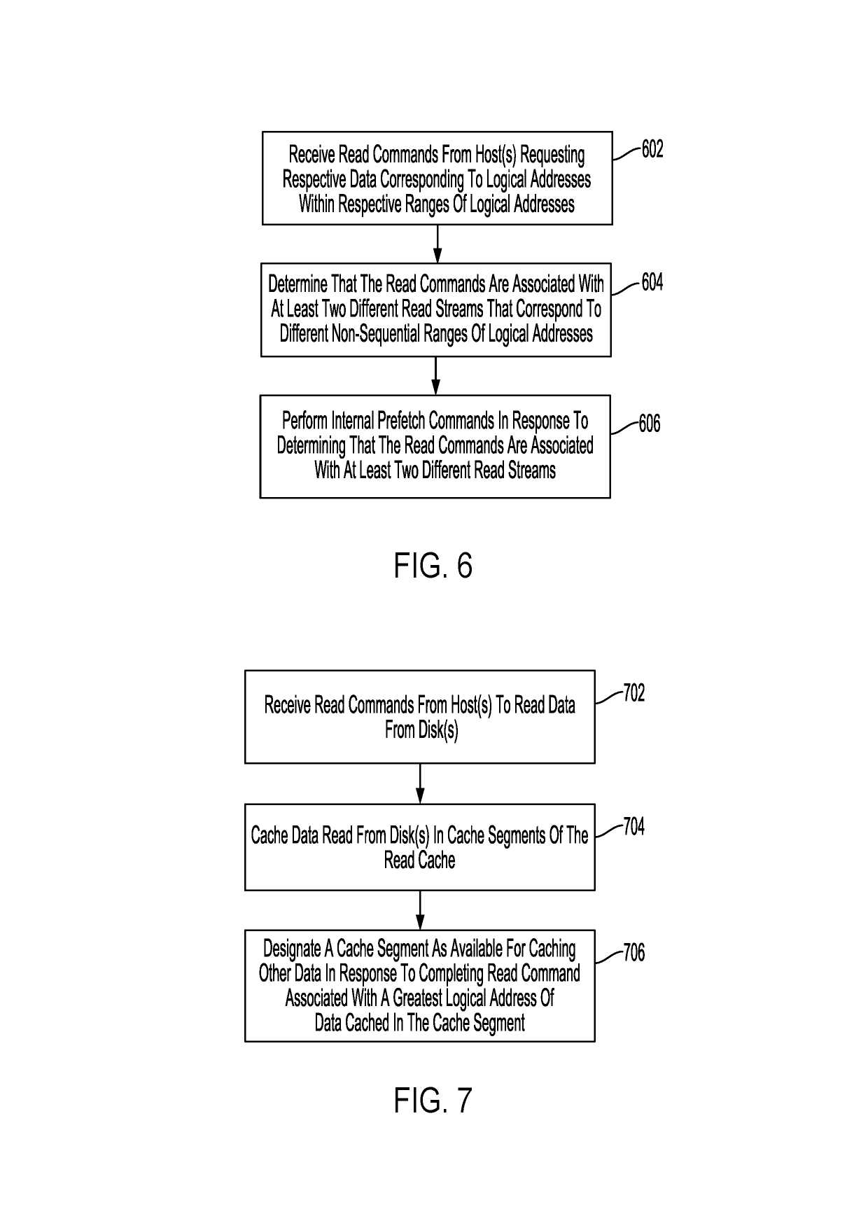

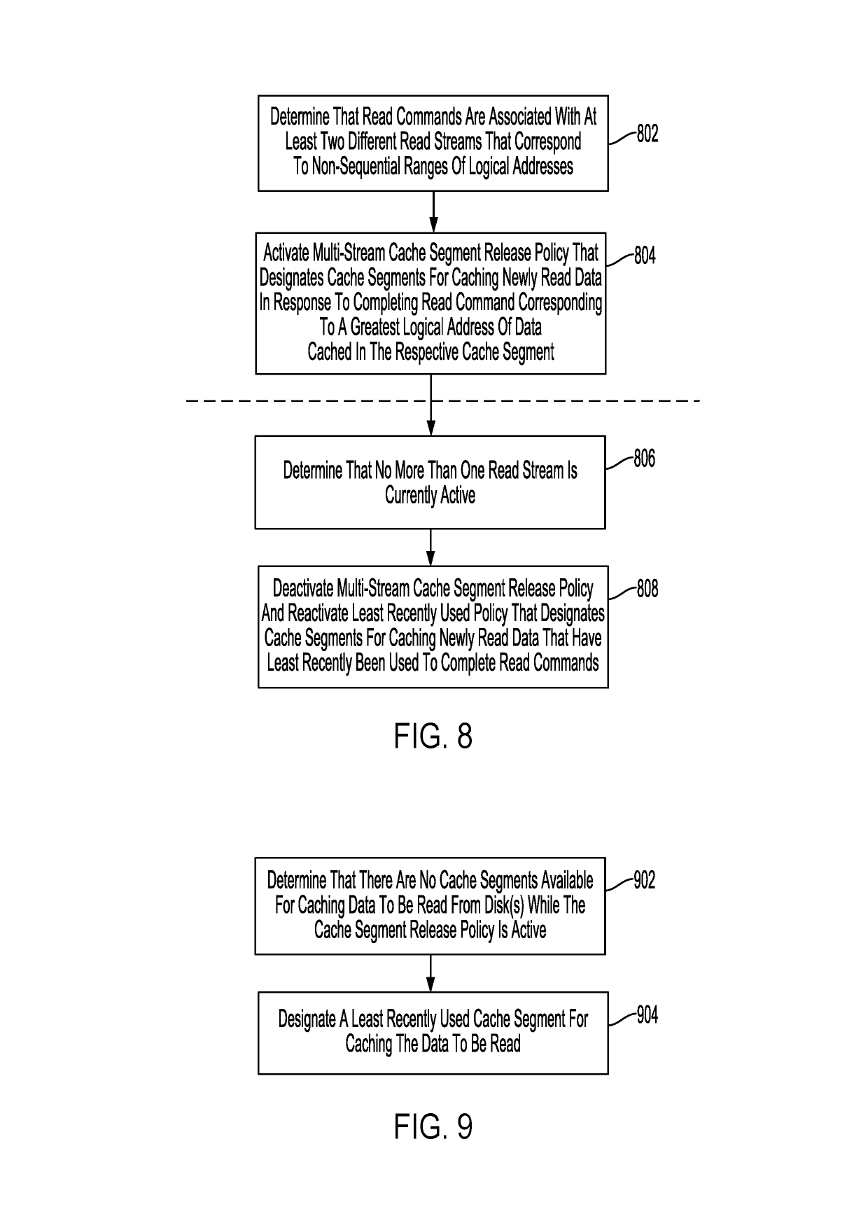

Those of ordinary skill in the art will appreciate with reference to the present disclosure that other implementations of the multi-stream cache segment release process of FIG. 7 may differ. For example, in some implementations, the cache segment release process may not be activated or triggered until after multiple read streams have been detected or otherwise determined for the received read commands. In such implementations, the DSD may switch between a LRU cache management policy and a multi-stream cache segment release policy depending on the workload, as discussed below with reference to the process of FIG. 8. In addition, and as discussed in more detail below for the process of FIG. 9, a LRU cache management policy may temporarily be used in situations where there is not an available cache segment for caching data to be read while using the multi-stream cache segment release policy.

FIG. 8 is a flowchart for a cache segment management process according to one or more embodiments. The process of FIG. 8 can be performed by, for example, circuitry 166 of DSD 100 executing cache manager 10 in FIG. 1. In this regard, circuitry 166 can, in some implementations, comprise a means for performing the functions of the cache segment management process of FIG. 8.

In block 802, the DSD determines that received read commands are associated with at least two different read streams that correspond to non-sequential ranges of logical addresses. In some implementations, the DSD may monitor the logical addresses for the read commands and determine that there are at least two active read streams when there are different groups of read commands whose logical addresses differ by a threshold number of logical addresses. In some implementations, the determination in block 802 may not be made until after a threshold number of read commands for each read stream has been received or after a predetermined period of time from receiving the first read command for the first detected read stream has elapsed.

In block 804, the DSD activates a multi-stream cache segment release policy that designates cache segments for caching newly read data in response to completing read commands that correspond to a greatest logical address of data cached in the respective cache segment. By using the multi-stream cache segment release policy when there is a multi-stream read workload, the DSD can take better advantage of the sequential nature of the read streams to prefetch data that is likely to follow for each read stream without having to release the LRU cache segment that may still cache data that will soon be requested by another read stream. Instead of releasing the LRU cache segment, cache segments that cache data for a completed read command associated with the greatest logical address for the cache segment can be released in place of the LRU cache segment.

In block 806, it is determined that no more than one read stream is currently active. The dashed line between blocks 804 and 806 in FIG. 8 indicates the passage of time during which the read workload may have changed. The determination that no more than one read stream is active in block 806 may be made by monitoring the active read streams and determining that no new read commands for other read streams have been received after a predetermined period of time. In some implementations, a cache manager of the DSD may keep a list or other data structure for identifying the active read streams.

In block 808, the DSD deactivates the multi-stream cache segment release policy in response to the determination that no more than one read stream is currently active. The DSD reactivates a LRU policy that designates cache segments for caching newly read data that have least recently been used to complete read commands. The LRU policy may work better than the multi-stream cache segment release policy for a single read stream or for read commands that are discrete and not part of a read stream. For such single read stream workloads and discrete read workloads, the additional prefetched data in the LRU cache segment is less likely to be requested by a host as compared to prefetched data cached in cache segments that have more recently been used to complete read commands. In some cases, the additional prefetched data can include data that has been part of a read-ahead prefetch or may be prefetched data that may remain from using internal prefetch commands from when the DSD was previously handling a multi-stream read workload.

Those of ordinary skill in the art will appreciate with reference to the present disclosure that other implementations of the cache segment management process of FIG. 8 may differ. For example, the activation of the multi-stream cache segment release policy may be triggered by the determination or detection of a different minimum number of read streams, such as by three or more read streams, as opposed to at least two read streams as in block 802 of FIG. 8.

FIG. 9 is a flowchart for a cache segment designation process according to one or more embodiments. The process of FIG. 9 can be performed by, for example, circuitry 166 of DSD 100 executing cache manager 10 in FIG. 1. In this regard, circuitry 166 can, in some implementations, comprise a means for performing the functions of the cache segment designation process of FIG. 9.

In block 902, the DSD determines that there are no cache segments available for caching data to be read from the at least one disk while the multi-stream cache segment release policy is active. In some implementations, the data to be read can be for internal prefetch commands that are used by the DSD to prefetch data for different read streams. In other implementations, the DSD may not be using internal prefetch commands but may still be using the multi-stream cache segment release policy for a multi-stream read workload.

In block 904, the DSD designates a least recently used cache segment for caching the data to be read. The least recently used cache segment can be the cache segment that was least recently accessed by a host task of the DSD for preparing a response to a read command received from a host. In this regard, the completion of the read command can refer to, for example, the sending of requested data for the command to a requesting host, the queuing of the requested data in a data transmission queue of the DSD, the packaging of the requested data in a packet, or another type of preparation or stage in responding to the read command.

The switch to using a LRU cache management policy to free up a cache segment while otherwise using the multi-stream cache segment release policy can be temporary in that the DSD will continue to use the multi-stream cache segment release policy after making the LRU cache segment available for reuse. This enables the continued caching of data, while still taking advantage of read streams’ tendency to read data corresponding to increasing logical addresses by continuing to use the multi-stream cache segment release policy.

Those of ordinary skill in the art will appreciate with reference to the present disclosure that other implementations of the cache segment designation process of FIG. 9 may differ. For example, in other implementations, the LRU cache policy may be temporarily activated when the available cache segments fall below a threshold number of cache segments, such as having only two or fewer cache segments available for caching newly read data.

The foregoing systems and methods for managing a read cache for multi-stream read workloads can provide a more efficient use of the read cache by releasing cache segments when data from the cache segment has been used for a read command corresponding to a greatest logical address for the cache segment. In addition, the disclosed DSD-ordered, internal prefetch commands provide a more efficient use of the read cache and improved read performance by being more independent from the scattered order in which read commands may be received for multiple read streams. The internal prefetch commands typically improve the read performance of the DSD for multi-stream workloads, as compared to conventional read-ahead prefetching, by reducing the amount of idle time spent waiting for the disk to rotate to a particular starting location for a non-sequential or non-contiguous read operation, and by reducing the seek time in moving heads in a less efficient manner over greater distances across the disk surfaces to perform reads in a less sequential manner.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general-purpose processor, a GPU, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

What is claimed is:

1. A Data Storage Device (DSD), comprising:
at least one disk configured to store data;
at least one head configured to read data from the at least one disk;
at least one memory configured to store a plurality of cache segments for caching data read from the at least one disk; and
circuitry configured to:
receive a plurality of read commands from one or more hosts, each read command of the plurality of read commands requesting data stored on the at least one disk corresponding to different ranges of logical addresses; and
perform a plurality of internal prefetch commands to cache prefetched data in respective cache segments of the plurality of cache segments, wherein the prefetched data corresponds to subsequent ranges of logical addresses that sequentially follow the different ranges of logical addresses; and
wherein the plurality of internal prefetch commands is performed in an order based, at least in part, on an overall time to move the at least one head to respective locations of the at least one disk to perform the plurality of internal prefetch commands.

2. The DSD of claim 1, wherein each cache segment of the plurality of cache segments has a predetermined data storage capacity.

3. The DSD of claim 1, wherein the circuitry is further configured to:
receive a first read command from a host requesting first data stored on the at least one disk, wherein the first data corresponds to a first logical address within an initial range of logical addresses of the different ranges of logical addresses;
in response to receiving the first read command, perform the first read command by at least in part caching first prefetched data including the requested first data in a first cache segment of the plurality of cache segments, the first prefetched data corresponding to the initial range of logical addresses;
perform an internal prefetch command of the plurality of internal prefetch commands to cache additional prefetched data in a second cache segment of the plurality of cache segments, wherein the additional prefetched data corresponds to a first range of logical addresses that sequentially follows the initial range of logical addresses;
receive a second read command from the host or from another host after receiving the first read command and before performing the internal prefetch command, the second read command requesting second data stored on the at least one disk that is not included in either the first prefetched data or in the additional prefetched data; and
cache the additional prefetched data in the second cache segment before caching the requested second data in a cache segment of the plurality of cache segments.

4. The DSD of claim 1, wherein the plurality of read commands is associated with at least two different read streams that request data stored on the at least one disk corresponding to non-sequential ranges of logical addresses.

5. The DSD of claim 1, wherein the circuitry is further configured to:
determine that the plurality of read commands is associated with at least two different read streams that request data stored on the at least one disk corresponding to non-sequential ranges of logical addresses; and
in response to determining that the plurality of read commands is associated with at least two different read streams, perform the plurality of internal prefetch commands to cache the prefetched data in the respective cache segments.

6. The DSD of claim 1, wherein the circuitry is further configured to:
in response to completing a read command that is associated with a greatest logical address of data cached in a cache segment of the plurality of cache segments, designate the cache segment as available for caching other data.

7. The DSD of claim 1, wherein the circuitry is further configured to:
determine that the plurality of read commands is associated with at least two different read streams that correspond to non-sequential ranges of logical addresses; and
based on determining that the plurality of read commands is associated with at least two different read streams, activate a multi-stream cache segment release policy that designates cache segments of the plurality of cache segments for caching newly read data in response to completing a read command associated with a greatest logical address of data cached in a respective cache segment.

8. A method of managing a read cache in at least one memory of a Data Storage Device (DSD), the method comprising:
receiving a plurality of read commands from one or more hosts to read data from at least one disk of the DSD;
caching data read from the at least one disk in a plurality of cache segments of the read cache, wherein at least a portion of the cached data includes data requested for the plurality of the received read commands; and
in response to completing a read command associated with a greatest logical address of data cached in a cache segment of the plurality of cache segments, designating the cache segment as available for caching other data.

9. The method of claim 8, further comprising:
determining that the plurality of read commands is associated with at least two different read streams that correspond to non-sequential ranges of logical addresses; and
based on determining that the plurality of read commands is associated with at least two different read streams, activating a multi-stream cache segment release policy that designates cache segments of the plurality of cache segments for caching newly read data in response to completing a read command associated with a greatest logical address of data cached in a respective cache segment.

10. The method of claim 9, further comprising, while the multi-stream cache segment release policy is active:
determining that there are no cache segments of the plurality of cache segments that are available for caching data to be read from the at least one disk; and
designating a least recently used cache segment of the plurality of cache segments as available for caching the data to be read, the least recently used cache segment being the cache segment of the plurality of cache segments that has least recently been used to complete a read command.

11. The method of claim 9, further comprising:
determining that no more than one read stream is currently active; and
based on determining that no more than one read stream is currently active, deactivating the multi-stream cache segment release policy and reactivating a least recently used policy that designates cache segments of the plurality of cache segments for caching newly read data that have least recently been used to complete a read command.

12. The method of claim 8, wherein each cache segment of the plurality of cache segments has a predetermined data storage capacity.

13. The method of claim 8, further comprising:
performing a plurality of internal prefetch commands to cache prefetched data in respective cache segments of the plurality of cache segments, wherein the prefetched data corresponds to subsequent ranges of logical addresses that sequentially follow different ranges of logical addresses including requested data for the plurality of read commands; and
wherein the plurality of internal prefetch commands is performed in an order based, at least in part, on an overall time to move at least one head of the DSD to respective locations of the at least one disk to perform the plurality of internal prefetch commands.

14. The method of claim 13, further comprising:
receiving a first read command from a host requesting first data stored on the at least one disk, wherein the first data corresponds to a first logical address within an initial range of logical addresses of the different ranges of logical addresses;
in response to receiving the first read command, performing the first read command by at least in part caching first prefetched data including the requested first data in a first cache segment of the plurality of cache segments, the first prefetched data corresponding to the initial range of logical addresses;
performing an internal prefetch command of the plurality of internal prefetch commands to cache additional prefetched data in a second cache segment of the plurality of cache segments, wherein the additional prefetched data corresponds to a first range of logical addresses that sequentially follows the initial range of logical addresses;
receiving a second read command from the host or from another host after receiving the first read command and before performing the internal prefetch command, the second read command requesting second data stored on the at least one disk that is not included in either the first prefetched data or in the additional prefetched data; and
caching the additional prefetched data in the second cache segment before caching the requested second data in a cache segment of the plurality of cache segments.

15. The method of claim 13, further comprising:
determining that the plurality of read commands is associated with at least two different read streams that request data stored on the at least one disk corresponding to non-sequential ranges of logical addresses; and
in response to determining that the plurality of read commands is associated with at least two different read streams, performing the plurality of internal prefetch commands to cache the prefetched data in the respective cache segments.

16. A Data Storage Device (DSD), comprising:
at least one disk configured to store data;
at least one head configured to read data from the at least one disk;
at least one memory configured to store a plurality of cache segments for caching data read from the at least one disk; and
means for:
receiving a plurality of read commands from one or more hosts, each read command of the plurality of read commands requesting data stored on the at least one disk corresponding to different ranges of logical addresses; and
performing a plurality of internal prefetch commands to cache prefetched data in respective cache segments of the plurality of cache segments, wherein the prefetched data corresponds to subsequent ranges of logical addresses that sequentially follow the different ranges of logical addresses; and
wherein the plurality of internal prefetch commands is performed in an order based, at least in part, on an overall time to move the at least one head to respective locations of the at least one disk to perform the plurality of internal prefetch commands.

17. The DSD of claim 16, wherein each cache segment of the plurality of cache segments has a predetermined data storage capacity.

18. The DSD of claim 16, further comprising means for:
receiving a first read command from a host requesting first data stored on the at least one disk, wherein the first data corresponds to a first logical address within an initial range of logical addresses of the different ranges of logical addresses;
in response to receiving the first read command, performing the first read command by at least in part caching first prefetched data including the requested first data in a first cache segment of the plurality of cache segments, the first prefetched data corresponding to the initial range of logical addresses;
performing an internal prefetch command of the plurality of internal prefetch commands to cache additional prefetched data in a second cache segment of the plurality of cache segments, wherein the additional prefetched data corresponds to a first range of logical addresses that sequentially follows the initial range of logical addresses;
receiving a second read command from the host or from another host after receiving the first read command and before performing the internal prefetch command, the second read command requesting second data stored on the at least one disk that is not included in either the first prefetched data or in the additional prefetched data; and
caching the additional prefetched data in the second cache segment before caching the requested second data in a cache segment of the plurality of cache segments.

19. The DSD of claim 16, further comprising means for:
determining that the plurality of read commands is associated with at least two different read streams that request data stored on the at least one disk corresponding to non-sequential ranges of logical addresses; and
in response to determining that the plurality of read commands is associated with at least two different read streams, performing the plurality of internal prefetch commands to cache the prefetched data in the respective cache segments.

20. The DSD of claim 16, further comprising means for:
in response to completing a read command that is associated with a greatest logical address of data cached in a cache segment of the plurality of cache segments, designating the cache segment as available for caching other data.
